(19) United States
(12) Patent Application Publication
(10) Pub. No.: US 2025/0347568 A1
(43) Pub. Date: Nov. 13, 2025

(54) METHOD FOR MEASURING TEMPERATURE OR THERMAL RESISTANCE, MONITORING THE THERMAL RESISTANCE

(71) Applicant: MITSUBISHI ELECTRIC CORPORATION, TOKYO (JP)

(72) Inventors: Pierre-Yves PICHON, RENNES Cedex 7 (FR); Vincent QUEMENER, RENNES Cedex 7 (FR)

(73) Assignee: MITSUBISHI ELECTRIC CORPORATION, TOKYO (JP)

(21) Appl. No.: 18/871,423

(22) PCT Filed: Dec. 27, 2022
(86) PCT No.: PCT/JP2022/048719

§ 371 Date: Dec. 3, 2024

(30) Foreign Application Priority Data
Jul. 7, 2022 (EP) 22306014.6

(51) Int. Cl. G01K 7/16; G01K 7/42

(52) U.S. Cl. CPC G01K 7/16; G01K 7/425; G01K 2217/00

(57) ABSTRACT

Method for measuring temperatures in a power electronic system comprising at least one power unit (PU) comprising at least one semiconductor switch(S) having a die connected to a heatsink (HS, 5) via a stack of m material layers Mi, i=1, 2 . . . m, and in which said at least one semiconductor switch is thermally connected in parallel with a heat source (10) via a connection layer Mj of the material layers Mi of the stack, the method comprising: —providing a limited current in said at least one semiconductor switch (S) when such semiconductor switch is in an open state such as it does not dissipate heat, said limited current being adapted for measuring a first temperature T1 of said at least one semiconductor switch using a thermal sensitive parameter of said at least one semiconductor switch in said open state, —calculating the temperature T_{Mj} of the connection layer Mj as being equal to said first temperature T1.

### TECHNICAL FIELD

The present disclosure concerns the field of power electronic systems having power semiconductors and more precisely power switching semiconductors and concerns a method for monitoring thermal resistance in such a power electronic system.

### BACKGROUND ART

In order to achieve higher current density in power modules, as an alternative to increasing the die areas of such modules, the adoption of multi-die power modules architecture is growing, where several semiconductor dies are electrically connected in parallel and perform the same function of a single switch. In the prior art, the power module lifetime is limited by the semiconductor junction temperature swing during the mission profile. Classical wear out mechanisms are generated by the combination of thermal cycles and coefficient of thermal expansion (CTE) mismatches leading to mechanical stresses between the different layers of a power module. These mechanical deformations and the excessive strain applied at the interface of different materials results in the degradation, or even failure, of the power module due to the formation of cracks and/or voids. In addition, the degradation of layers between the semiconductor and the cooling system, such as a heatsink, results in an increased thermal resistance and consequently in an increase of the amplitude of the temperature swing, for a given load condition. The most critical failure mechanisms relate to the electrical interconnection packages closest to the semiconductor die and are the bond wires lift off and die attach degradation in particular with delamination of Sn-based solder or Ag-based sintered layer. Documents discussing such issues are for example:
N. Degrenne, J. Ewanchuk, E. David, R. Boldyrjew and S. Mollov, “A Review of Prognostics and Health Management for Power,” Annual Conference of the Prognostics and Health Management Society, (2015) 1-11;
Mauro Ciappa, “Selected failure mechanisms of modern power modules,” Microelectronics Reliability, 42 (2002) 653-667;
P-Y. Pichon and J. Brandelero, “Relative importance of solder and wire bond defects on the maxi-mum junction temperature of IGBT devices,” Microelectronics Reliability, 126 (2021) 114250.

In this context, there is high technological interest to monitor the health condition of these layers and assess the remaining life of the power module before actual failure of the module occurs. Specifically, on-line condition monitoring of the die attach layer represents a key technology to monitor the degradation level, avoid failures, plan maintenance, and, based on this monitoring, to develop strategies to extend the lifetime of power modules.

Testing methods exist and document CN103175861A discloses a junction-to-case thermal resistance testing method, document CN103792476A concerns a thermal resistance measuring method for semiconductor device, document EP 0 708 327 B1 concerns a method and apparatus for thermal impedance evaluation of packaged semiconductor components, document U.S. Pat. No. 7,356,441 B2 concerns a junction temperature prediction method and apparatus for use in a power conversion module, document CN107219016A provides a method and system to calculate an IGBT module transient state junction temperature.

The thermal impedance is defined as Zth_{j-ref}=(T(t)−T_{ref})/Pdiss; where Pdiss is a change of dissipated power, T(t) the temperature response of the device to this power change, and Tref is a reference temperature, for example a heat sink temperature THS, or a cooling fluid temperature TCF, or a cooling means temperature TCM. The thermal resistance is defined as Rth_{j-ref}=lim(Zth) (t->∞).

In the prior art, the degradation level of the packaging layers is measured and monitored using different techniques based on thermal impedance measurements:
With thermistances, calibrated temperature-sensitive electrical resistors, which are typically built-in in classical power modules, thermally connected to the ceramic isolation plate of the semiconductor dies, and electrically connected to terminals of the power module. These devices allow monitoring the temperature of the ceramic plate during the life of the module. By monitoring the evolution of the temperature at the position of the device it is possible to monitor a change of thermal impedance between the heatsink and the module.
Using several thermal sensitive electrical parameters (TSEP) to measure the temperature of the semiconductor dies during operation of such semiconductor. TSEP are electrical parameters of the semiconductor that are sensitive to the temperature, can be calibrated, and can thus give information on the temperature of the semiconductors. Thus, the thermal resistance information between a semiconductor and the heatsink can be extracted during the lifetime of the module, provided the power dissipated in the semiconductor Pdiss is known;
Through thermal impedance measurements techniques which are transient thermal response techniques which can give information on the degradation of the different interfaces of the power module. The technique typically consists in:
   First, applying a starting steady-state thermal condition on the power module using the semiconductor switch as an active device. This starting condition can either be a zero-power condition, or a condition where a recorded constant power is dissipated at the semiconductor.
   Second, applying a controlled power step increase (in case the start condition is a zero power condition) or a power step decrease (in case the start condition is a constant power condition), recording the power change, and then recording the evolution of the semiconductor temperature until the new steady state thermal condition is reached.
   Finally, describing the recorded temperature transient behavior described by using an equivalent Foster or Cauer network which represent the thermal structure of the power module with several RC elements. A fitting of the temperature transient using the foster equation allow to extract the resistance and capacitance of the different part of the power module, giving information of the evolution of thermal resistance and capacitance.

These techniques are particularly sensitive of solder attach and degradation of the different layer constituting the power module. Typically, the thermal impedance measurement is mainly measured in offline condition by mounting the device in a measurement test bench and by controlling the load, measuring the dissipated power in the device, and measuring the temperature transient with a dedicated sensor.

Several experiments have been reported in the literature and have demonstrated a clear correlation of the degradation of solder layer by an evolution of the thermal transient behavior after power cycling the power module.

The available transient thermal techniques (such as thermal impedance, ZTH) are difficult to implement in an on-line operation of the power module, as it remains difficult to measure the cooling/heating transient temperature during the operation of the power device, with a sufficient high rate of data acquisition and the dissipated power of each device must be controlled and known in order to measure the thermal impedance and remains difficult to measure it, in particular in the case of multichip power module where the current is shared between different parallelly interconnected dies.

Available online TSEP monitoring techniques allow real-time monitoring the temperature of the semiconductor dies, and possibly detect increase in the thermal resistance between the semiconductor and the heatsink Rth_{j-HS}, provided similar power dissipation conditions can be reproduced during the measurements. However, the knowledge of Rth_{j-HS} does not allow to discriminate which layer or interface has the most degraded in the package stack.

Thermistances are typically thermally connected to intermediate layers of the power module package stack, typically to the ceramic isolation plate, and the monitoring of its evolution, together with the evolution of a semiconductor die thermally connected to the same ceramic isolation plate, i.e. a DBC direct bonded copper ceramic substrate corresponding to the direct mating of copper and ceramic, enables in principle to discriminate whether the thermal resistance of the bond Rth_{j-DBC}, or the thermal resistance between the bond and heatsink Rth_{DBC-HS} has degraded most. However, integrating thermistances represents an additional production cost, need additional external leads, additional ceramic isolation plate area, and thus generally increases the cost, volume, and weight of the power module. Therefore, typically only one thermistance is integrated on power modules, and thus the temperature measured by it is representative only of the temperature of the closest semiconductor chip.

### SUMMARY OF INVENTION

In view of this prior art, the present disclosure proposes to use individual control of semiconductor switches in power modules to provide open state configurations of such switches where a TSEP measurement is done in order to obtain a temperature measurement. This is done for a module with one or more semiconductor switches and each die in a multichip power module in order to detect a degraded layer part of the power module. This will allow to determine which part of the equipment using such modules is in a degraded state in order to manage a better maintenance planning.

More precisely, the present disclosure concerns a method for measuring temperatures or thermal resistances in a power electronic system comprising at least a first power unit and a heat source thermally connected through a connection layer to a cooling means, comprising, while said first power unit is in an open state such as it does not dissipate heat, providing a limited current in said first power unit said limited current being unable to turn said first power unit in a power conducting state, measuring a temperature T1 of said first power unit using a thermal sensitive electrical parameter TSEP of said first power unit, calculating a temperature T_{CL} of the connection layer as being equal to such first temperature T1 since said first power unit in an open state does not generate heat.

This method allows to simply get a measurement of the connection layer temperature without the need of a thermistance.

The heat source may be a second power unit or any heating element.

The method may comprise further measuring a temperature T_{CM} of cooling means of the power unit and calculating the difference of temperature T1−T_{CM} between said connection layer and said cooling means.

This permits to obtain information on the thermal resistance between the connection layer and the cooling means.

When the heat source is a second power unit, the method may comprise further:
measuring a temperature T2 of said second power unit using a TSEP of said second power unit,
comparing the difference T1−T_{CM} with the difference T2−T_{CM}
comparing the thermal resistance R_{2-CL} between the second power unit and the connection layer to the thermal resistance R_{CL-CM} between the connection layer and the cooling means through the calculations:

R_{2-CL}/R_{CL-CM}=(T_{CL}−T_{CM})/(T2−T_{CL})−(T1−T_{CM})/(T2−T1) since T1=T_{CL} such calculation being independent of Q, where Q is the heat flow value applied between said second power unit and said connection layer.

This gives the information of thermal resistance of layers without the need of sensors except a sensor on the cooling means.

Said first power unit and said second power units may be semiconductor switches thermally connected to said connection layer through a first stack of material layers, and said cooling means may be a heatsink, wherein said connection layer is thermally connected to said heatsink through a second stack of material layers.

Said first power unit and said second power units may be semiconductor switches, said connection layer being a ceramic layer such as a direct bonded copper ceramic layer or an active metal brazed layer attached directly to said heatsink or attached to said heatsink through a baseplate BP.

Said first power unit may be a first half bridge power unit comprising a first top switch and a first bottom switch, said first top switch and said first bottom switch having dies attached to a first ceramic layer such as a direct bonded copper ceramic layer or an active metal brazed layer through a first die attach layer and said second electronic unit is a second half bridge power unit comprising a second top switch and a second bottom switch, said top switch and bottom switch having dies attached to a second direct bonded copper ceramic layer through a second die attach layer and wherein said first direct bonded copper ceramic layer and second direct bonded copper ceramic layer are attached to a common heatsink through a solder layer and a baseplate layer, said method comprising turning off both the first top switch and the first bottom switch of the first half bridge power unit while the second top switch and the second bottom switch of the second half bridge power unit are active and
measuring a temperature T2 of the second top switch through TSEP of said second top switch, measuring a temperature T1 of the first top switch or the first bottom switch through TSEP of said first top switch or said first bottom switch by providing a limited current in said first top switch or said first bottom switch, said limited current being unable to turn said first top switch unit in a power conducting state, considering the temperature of the baseplate as equal to said temperature T1 calculating the temperature difference between said second top switch and the baseplate R_{2-BP}=T2−T_{BP}=T2−T1
measuring a temperature of the heatsink T_{HS} and then calculating a ratio r2=(T2−T_{BP})/(T_{BP}−T_{HS}) to compare the thermal resistance of the second die attach layer, the second DBC layer, the solder layer with that between the baseplate and the heat sink.

Each power unit may be turned off in sequence while the other power unit is active to complete the measurements on all power units.

The power electronic system may comprise more than one half bridge power units and one of said half bridges may be turned off to provide a temperature measurement of the baseplate while measurements of thermal resistance and thermal resistance ratios are conducted on the others of said half bridges, each of said half bridges being turned off in sequence while the others are active to provide a complete testing of the half bridges of the power electronic system.

The power electronic system may comprise a first power module having a first pair of half bridges each having a top switch an a bottom switch and a DBC layer connected to a first baseplate and comprises a second power module having a second pair of half bridges each having a top switch an a bottom switch and a DBC layer connected to a second baseplate, said first baseplate and said second baseplate being attached through a thermal contact material to a heatsink in contact with a cooling fluid, the power electronic system comprising further gate driver circuitries independent for each of said switches, said method comprising measuring the thermal resistance R_{PU1-HS} between a top switch or a bottom switch of a first power module and the heatsink and the thermal resistance R_{HS-CF} between the heatsink and the cooling fluid and comparing said thermal resistances through the steps of:
maintaining all the devices of a second power module open and measuring the temperature T_{HS} of the heatsink contact surface using a TSEP temperature measurements of one or a combination of the switches of said second power module, while the switching functions of the power electronic system are carried out by the switches of the first power module, and at the same time measuring the temperatures T2 of at least one of the devices of said first power module through its TSEP, measuring a temperature T_{CF} of the cooling fluid, and,
calculating a ratio r3=(T2−T_{HS})/(T_{HS}−T_{CF}) to compare the thermal resistance of the first power module, first baseplate, first thermal contact material with the thermal resistance between the heat sink contact surface and the cooling fluid, said method comprising further carrying the same steps with the switches of the first power module open while the switching functions of the power electronic system are carried out by the switches of the second power module.

Combining the methods at the switch level, the power unit level and the module level permits to obtain measures of the thermal resistance ratio at several levels in a stack of modules on a heatsink and cooling fluid.

Said first power unit may be forced in said open state during the measurements of temperature or thermal resistances.

This permits to schedule the measurement sequences.

The disclosure concerns also a method for monitoring the thermal resistance of power units of a power electronic system comprising acquiring initial thermal resistances of such power units through the methods disclosed, storing said initial thermal resistances and a ratio between an initial thermal resistance between said power units and the connection layer of such power units to the thermal resistance between the connection layer and the cooling means, repeating said method during the life of the power electronic system to acquire further thermal resistances and further ratios, comparing said further thermal resistances and said further ratios to said initial thermal resistances and said initial ratios to detect a modification of thermal resistances and ratios.

The method for monitoring may comprise comparing a modification of said thermal resistance to a predefined threshold value and raising a warning in case of a value of said thermal resistances or said ratios above said threshold value.

The method may comprise:
periodically recording at a time interval t_{sampling} the temperatures Tj of at least one semiconductor device j of the power electronic system such as a power converter and storing the data in a memory.
periodically calculating a mean temperature T_{mean,j} and a standard deviation σ_{mean,j} of at least the semiconductor j at a time interval tₑᵥₐₗ using a data sample Tnj, . . . , Tmj, such as an integration time t_{averaging} is at least a significant portion of the thermal constant of the power converter.
at least if the conditions T_{mean,j}>C1×T_{HS}, and σ_{mean,j}<C2×(T_{mean,j}−T_{HS}) are respected, doing the measurement process where C1 is a constant larger than 1 and C2 a constant smaller than 1.

C1 may be in a range between 1.1 to 5.

C2 being a constant that is between 0.2 to 0.05, the condition σ_{mean,j}<C2*(T_{mean,j}−T_{HS}) being the condition detecting the steady state nature of the operation, by comparing the standard deviation of the temperature samples with the average temperature difference between the semiconductor and the heat sink during the sampling time.

The time interval t_{sampling} may be a multiple of the inverse of the switching frequency of a power converter: t_{sampling}=n/f_{PWM}.

The temperature T_{mean,j} may be calculated using the arithmetic mean, or the median of the data sample Tnj . . . Tjm.

The integration time t_{averaging} may be greater than a thermal constant of the power electronic system.

The time interval tₑᵥₐₗ may be a time interval larger than t_{averaging}.

The switches of powers units PUx, x=1 to n, where n is the total number of switches, may be controlled independently from each other and the method may comprise measuring the coupling impedance between a power unit PUi and a power unit PUj i≠j, by a sequence comprising:
1/ switching off all switches of power units PUj, and maintaining the switches of power units PUi active,
2/ measuring the temperature Tx of all power units PUx,
3/ measuring the temperature of the heatsink T_{HS},
4/ calculating the temperature differences ΔTx=Tx−T_{HS},
5/ comparing the ΔTi with ΔTx such as to detect a change in a coupling thermal resistance.

Said sequence may be repeated several times during the life of the product.

The method may comprise measuring the power dissipated in a power unit PUi using an electrical model Pi (IL, Vbus, fPWM, Ti, α . . . ) of such power unit, where IL is the measured load power, Ti is the measured temperature of the power unit PUi, Vbus is the known or measured bus voltage of the power unit PUi, fPWM is the switching frequency of such power unit, and a is the duty cycle of such power unit, and calculating coupling resistances as ΔTx/Pi.

The present disclosure concerns also a software comprising instructions for implementing the method when executed in a controller of said power system and a computer readable non-volatile medium on which the software is recorded.

A detailed description of exemplary embodiments of the invention will be discussed hereunder in reference to the attached drawings.

### BRIEF DESCRIPTION OF DRAWINGS

FIG. 1 shows a schematic view of an embodiment of a power electronic system with a power unit, having one semiconductor die, adapted to the process of the present disclosure.

FIG. 2 shows a schematic view of an embodiment of a power electronic system with one power unit, with two semiconductor dies, adapted to the process of the present disclosure.

FIG. 3 shows a schematic view of an embodiment of a power electronic system with two power units, each unit having one pairs of semiconductor switch dies on a single DBC substrate, adapted to the process of the present disclosure.

FIG. 4 shows the electrical circuit of the power electronic system of FIG. 3.

FIG. 5 shows a schematic view of an embodiment of a power electronic system with three power units, each having one pairs of semiconductor switch dies on a single DBC substrate, adapted to the process of the present disclosure.

FIG. 6 shows the electrical circuit of the power electronic system of FIG. 5.

FIG. 7 shows a schematic view of an embodiment of a power electronic system with two power units each having four semiconductor dies adapted to the process of the present disclosure.

FIG. 8 shows the electrical circuit of the power electronic system of FIG. 7.

FIG. 9A shows a flowchart of example of method steps embodiment.

FIG. 9B shows a flowchart of example of method steps embodiment.

FIG. 9C shows a flowchart of example of method steps embodiment.

FIG. 9D shows a flowchart of example of method steps embodiment.

FIG. 10 shows an exemplary general flowchart.

### DESCRIPTION OF EMBODIMENTS

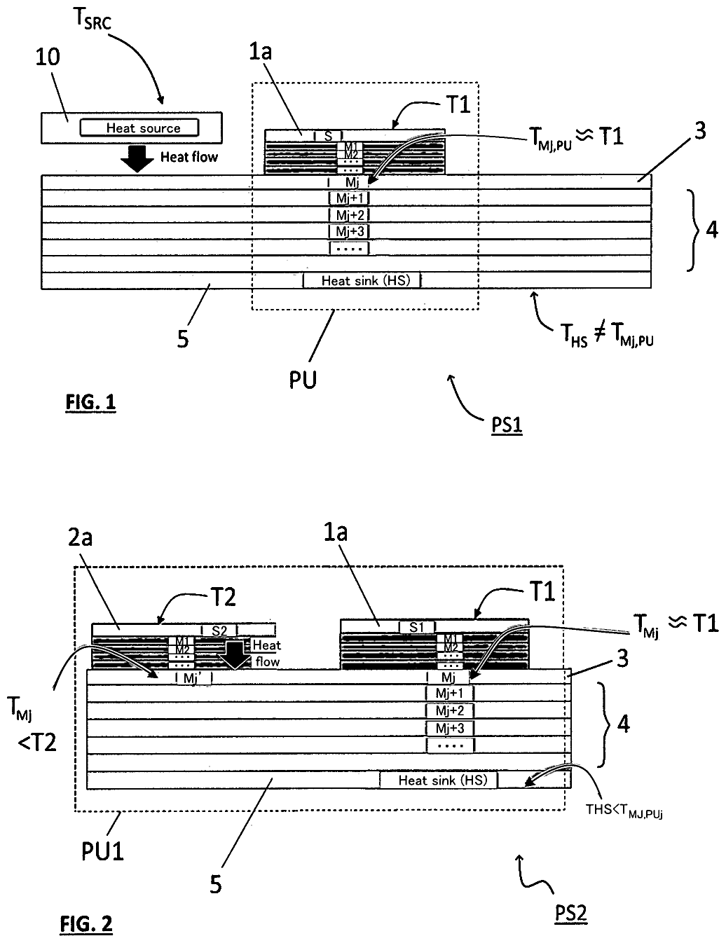

The method for measuring temperatures in a power electronic system of the present disclosure permits several measurements depending on the type of system. In FIG. 1 a power unit PU comprises a semiconductor switch having a die 1a connected to a heatsink HS, 5 via a stack of m material layers Mi, i=1, 2 . . . m. In this stack, layers M1 to Mj−1 are located between the die 1a and layer Mj which could be a DBC layer. The semiconductor switch is thermally connected in parallel with a heat source 10 at a temperature T_{SRC} via such layer Mj 3 forming a connection layer Mj of the material layers Mi of the stack.

Under Layer Mj is a further stack 4 of layers Mj+1 to Mm, layer Mm being connected to a heatsink HS 5.

The method comprises providing a limited current in said at least one semiconductor switch 1a in said open state, said limited current being adapted for measuring a first temperature T1 of said at least one semiconductor switch using a thermal sensitive parameter (TSEP) of said at least one semiconductor switch in said open state.

In such situation, the temperature of the semiconductor switch that does not dissipate heat is close or equal to the temperature of the DBC layer Mj 3. It is then possible to calculate the temperature T_{Mj} of the connection layer Mj as being equal to said first temperature T1 obtained through the TSEP measurement.

The TSEP measurement may use parameters such as gate resistance or other parameter which may be measured using existing electrical measurement features of the power unit.

Traditional semiconductor switches usually are blocked with a V_{GE} voltage of around −8V and conducting with a V_{GE} voltage around +15V and may drive currents of tens or hundreds of Amps.

In the present case the measurement of T1 through a TSEP parameter is done with an injection of a small current, e.g., pulses of tens of milliamperes e.g. 25 mA in the gate-emitter junction, for a duration of less than tens microseconds with a current source, allows to measure of the gate/emitter resistance of the semiconductor. With such a small current injection the VGE voltage of such semiconductor does not rise sufficiently to enable conduction of the switch.

Using the measurement of the internal gate resistance Rg1 of at least one semiconductor of the switch of PU1 permits to avoid any additional external sensor for measuring the junction temperature T1. Consequently, the temperature of the layer Mj can be determined using only the control terminals of the power electronic system PS.

The temperature T1 of S1 is measured using the gate resistance Rg1 of S1 using a calibration curve. For example, the calibration curve relates T1 and the gate resistance of switch S1 as:

T1=δR1*Rg1+R01

The semiconductor switches may be semiconductors switch such as silicon, silicon carbide, or GaAs semiconductors, in a silicon insulated gate bipolar transistor (IGBT) or a MOSFET configuration.

The general principle of the disclosure is that, because the switch of the power unit PU is purposely maintained open, and its temperature can be measured, it can advantageously be used as a temperature sensor to measure the temperature of the layer Mj. Thus, the semiconductor switch serves the additional function of a temperature sensor of the layer Mj.

In the case of FIG. 1, the heat source 10 may be any system that generate heat losses and that has a thermal connection to layer Mj, such as the temperature of Mj is different from that of the heatsink, even if the power unit PU does not generate losses. For example, the heat source may be a resistance submitted to an electrical current flow, a mechanical system that generate losses via friction, an inductance submitted to a magnetic flux, a thermal radiation source that changes the temperature of Mj, or any source that has a radiative, convective, inductive, conductive thermal connection to layer Mj.

In order to permit such measurement, the method may comprise maintaining said semiconductor switch 1a in an open state such as it does not dissipate heat or detecting that such semiconductor switch is in said open state. In one example, the power unit may be thermally connected to a motor body, does not transfer energy, and is used to monitor the temperature of the motor body.

By doing measurements when the switch is open, the main electrical function of the semiconductor switch is not affected because the switch is not active and does not transfer energy. The additional function of temperature measurement is only done when the switch does not supply power.

The method of the present disclosure is adapted to power modules where the material structure above the semiconductor die 1a does not dissipate significant heat, compared to the stack of layers between the semiconductor switch die and the connection layer Mj 3. Therefore, advantageously, even if the thermal contact between the semiconductor switch die 1a and layer Mj is poor (for example, because the thermal contact is degraded), the temperature T_{Mj} of the material Mj at the position under such die 1a is close enough to that of the semiconductor die 1a, so that it can be approximated that these temperatures are the same. For example, the thermal resistance between the top of the semiconductor die 1a and the heatsink is more than a factor 5 of that between the semiconductor die 1a and Mj, usually more than a factor 10 and often more than a factor 20. In example, only a small surface area of the top surface of the semiconductor die 1a is connected to the heatsink via a metal, for example this contact area is less than 10%, or less than 5%, and this area is minimized such as to only provide, for example sufficient electrical connection of the top surface, such as, for example wire connections to the terminals. In another example, most of the top surface area of the semiconductor die 1a usually 90% to 95% is covered by a thermally insulating material, e.g., an epoxy based potting compound of a silicone gel compound with a thermal conductivity of less than 2 W/(m·K) [most thermally conductive epoxies have a thermal conductivity in the range 1-1.6 W/(m·K)], or preferably less than 1 W/(m·K) which provides a very limited loss with respect to the transfer of heat between the die and layer Mj.

In such case, the semiconductor switch may be used as a temperature sensor for said heat source 10 assuming that the heat source having a temperature T_{SRC} is in contact with layer Mj:

T1=T_{Mj}=T_{src} or close to T_{src}.

In FIG. 2, the power electronic system is a power unit PU1 comprising two semiconductor switches each having a die 1a, 2a connected to a heatsink HS 5 via a similar stack of m material layers Mi, i=1, 2 . . . m. The two semiconductor switches are thermally connected in parallel via the connection layer Mj 3 of the stack.

In such case, each of the two semiconductor switches may form said heat source and may be used alternately to measure the temperature using the method herein disclosed.

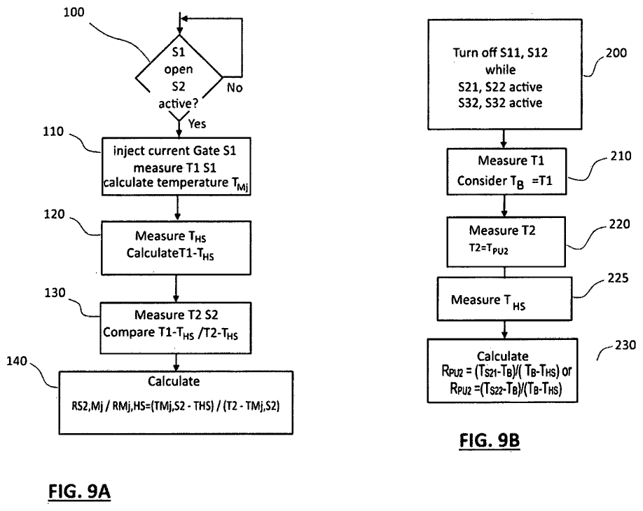

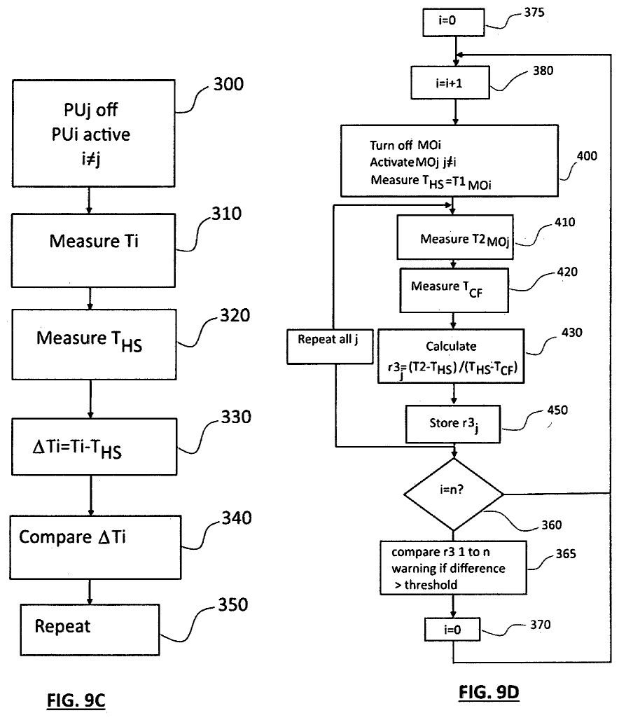

In such a situation, the method as depicted in FIG. 9A comprises:
maintaining a first of said two semiconductor switches, e.g., switch S1 on die 1a, in an open state, such as it does not dissipate heat, or detecting that a first of said two semiconductor switches is in said open state while at least a second switch S2 on die 2a is in a conductive state to form said heat source 100, and then, injecting a gate current in the gate of semiconductor S1 and measuring a first temperature T1 of die 1a of the first switch S1 using a thermal sensitive parameter of said first semiconductor switch 110,
calculating the temperature T_{CL} of the connection layer as being equal to such first temperature T1 since said first switch S1 does not generate heat.
measuring a temperature T_{HS} of the heatsink of the power electronic system at step 120,
comparing the difference T1−T_{HS} with the difference T2−T_{HS},

In such condition, the method may comprise measuring a temperature T2 of die 2a of the second switch S2 in a conductive state, such measurement being done preferably also using a TSEP parameter of said second switch S2, 130,
comparing the thermal resistance R_{S2,Mj} between the die of the second S2 of said at least two semiconductor switches and the layer Mj to the thermal resistance R_{Mj,HS} between Mj and the heatsink through the calculations at step 140:

$${R}_{S 2 , Mj} = Q / ( T 2 - {T}_{Mj , S 2} ) \\ {R}_{Mj , HS} = Q / ( {T}_{Mj , S 2} - {T}_{HS} ) \\ {R}_{S 2 , Mj} / {R}_{Mj , HS} = ( {T}_{Mj , S 2} - {T}_{HS} ) / ( T2 - {T}_{Mj , S 2} )$$

which becomes independent of Q where Q is the heat flow value applied between said second of said at least two semiconductors and said connection layer Mj.

This measurement benefits from the following:

The semiconductor S1 is positioned on the layer Mj such as it measures a temperature T_{Mj} of Mj close to the temperature T_{Mj′} at the position under the semiconductor S2: T_{Mj′}, S2≈T_{Mj},S1. For example, the thermal impedance between the point of Mj′ under the semiconductor S2 and the point of Mj under the semiconductor S1 is a small fraction of the thermal impedance between Mj and the heat sink HS, for example <20%, and usually <10%.

When the temperature T_{Mj} under semiconductor S1 is close enough to the temperature of the semiconductor S1, it can be approximated that these temperatures are the same: T_{Mj}=T1.

In this example, T_{Mj}=T_{Mj′}=T1. The semiconductor S1 is used as a sensor to measure the temperature of Mj at the position under the semiconductor S1, and it can be approximated that the temperatures of Mj′ under the semiconductor S2 and the temperature of the semiconductor of S1 are the same.

Under these conditions, it follows that the ratio of thermal resistance between the semiconductor of S2 and layer Mj, with that of the layer Mj and the heat sink HS can be expressed as:

$$r = {R}_{S 2 - Mj} / {R}_{Mj - HS} = ( T 1 - {T}_{HS} ) / ( T 2 - T 1 ) .$$

Therefore, advantageously, without additional temperature sensors than the temperature measurement of the semiconductors S1 and S2, and the temperature measurement of HS, information can be gained on the relative thermal resistance R_{S2,Mj} and R_{Mj-HS}. By reversing the measurements that is by keeping S2 open, it can be measured the relative thermal resistance R_{S1,Mj}/R_{Mj-HS}.

With the disclosed method the thermal resistance R_{S2,Mj} between the die of the second semiconductor S2 and layer Mj can be compared to the resistance R_{Mj,HS} between Mj and the heat sink, without needing to know the dissipated power in such semiconductor.

In consequence the method permits to:
monitor a change of thermal resistance R_{S2,Mj} during the life of the power electronic system PS, assuming the thermal resistance R_{Mj,HS} does not change, OR
monitor a change of thermal resistance R_{Mj,HS} during the life of the power electronic system PS, assuming the thermal resistance R_{S2-Mj} does not change.

The measurement of the temperatures T1, T2, and T_{HS} are preferably acquired in steady-state thermal conditions or close to steady state thermal conditions and the measurements are repeated alternating switches S1 and S2 to monitor the possible degradation of one of the resistances of the intermediate layers between S1 and Mj or between S2 and Mj.

As said above, a similar measurement process may be done when the switch S2 is in open state and the switch S1 is conducting to obtain a comparison of the thermal resistance R_{S1,Mj} between the die of the first semiconductor S1 and layer Mj and the resistance R_{Mj,HS} between Mj and the heat sink to obtain thermal data on the complete unit.

Here both the temperatures T1 and T2 of switches S1 and S2 are measured using the gate resistance of S1 and S2 using respective calibration curves. For example, the calibration curves relate T1, respectively T2 and Rg1, respectively Rg2 linearly as:

$$T 1 = δ R 1 * Rg 1 + R 01 \\ T 2 = δ R 2 * Rg 2 + R 02$$

Two situations allow the use of the method. In a first type of circuit, the semiconductors having dies 1a, 2a are not connected electrically in parallel, have separated gate commands and do not perform the function of a single switch. In such case where each switch possesses its gate driver, the method is implemented when one of the switches is in an open state during operation of the module. In a second type of circuits, the two semiconductor switches are connected in parallel but driven by separate gate drivers commands and in such case one of the switches is kept in an open state while the other is conducting for a period sufficient to implement the method. This can be done periodically for a limited time such as a hundred of milliseconds to one second in order to provide thermal data on the module. This method needs that the gate commands of the switches are separated or comprise a different control line.

It is straightforward to expert in the field of power electronic modules design that the conditions in the examples presented here are generally satisfied. For example, in such modules, the layer Mj is a Direct Bonded Copper (DBC) ceramic substrate made mainly of an alumina (Al₂O₃) substrate of several mm thick of thermal conductivity between 20 and 30 W/(m·K), and the semiconductor chips of S1 and S2 are spaced less than 5 mm apart, such as TMj,S2≈TMj,S1. In addition, the power electronic module has for encapsulating compound materials of low thermal conductivity.

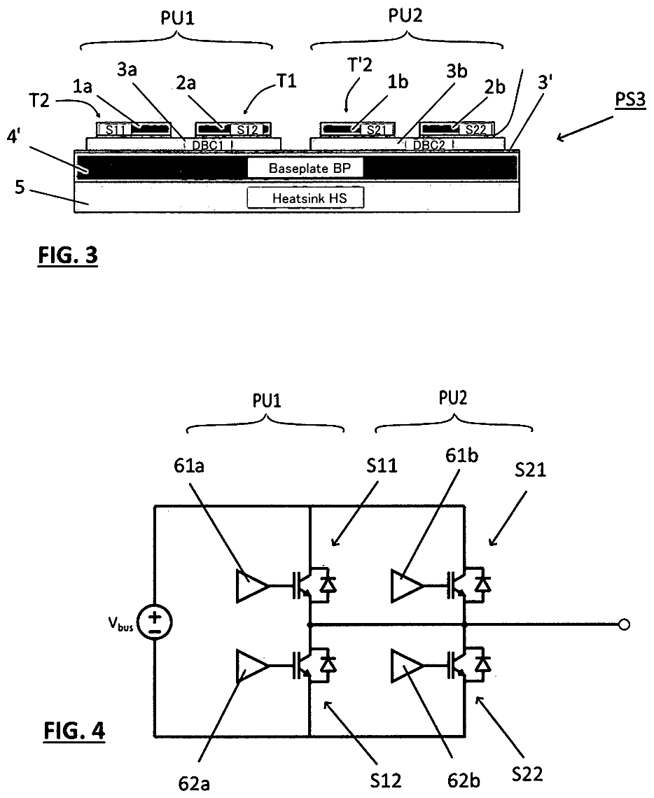

In FIGS. 3 and 4, a first power unit PU1 comprises two semiconductor switches S11, S12 each having a freewheeling diode and driven by a gate driver 61a, 62a where switch S11 is a top switch of a half-bridge and switch S12 is the bottom switch of such half-bridge. Such switches are made of dies 1a, 2a bonded to a single ceramic substrate 3a and a second power unit PU2 comprises two semiconductor switches S21, S22 each having a freewheeling diode and driven by a gate driver 61b, 62b where switch S21 is a top switch of a half-bridge and switch S22 is the bottom switch of such half-bridge. Such switches are made with dies 1b, 2b bonded to a single ceramic substrate 3b.

Each of said power units are connected to a single heatsink 5 through a layer 3′ and one or more sub layers 4′ forming a baseplate.

In such designs, the direct bonded copper ceramic layers 3a, 3b are often the most critical layers and can limit the lifetime of the power module, it is of interest to measure the temperature of such DBC layers. In order to get information of the die attach thermal resistance degradation and the method, similar to the method of FIG. 9A, comprises the steps:

A—Maintaining open one neighbor semiconductor sharing the same DBC layer of a die of interest where the thermal resistance or the damage indicator is to be evaluated using its gate driver. Since this open semiconductor is electrically connected in parallel with another die as shown in FIG. 4, the power converter can still perform its task, albeit with a reduced maximum current rating.

As an example, the semiconductor switch S11 is maintained open during the TSEP measurement to avoid dissipating heat. In example, if the semiconductor S11 may be a silicon-based IGBT having its gate voltage maintained at −8V while the other semiconductors electrically connected in parallel with S11 is electrically active and perform the normal operation of the switch.

B—Measuring the temperature T_{die} of the die of interest, the temperature T_{DBC} of the DBC layer using the deactivated neighbor die, and the temperature of the heatsink T_{HS}.

In example, keeping the switch S11 on die 1a open permits to carry measurements on die 2a sharing DBC layer Mj1 with die 1a while the converter will still have switch S21 on die 1b to carry current.

Repeating such steps at regular time intervals during the lifetime of the product, and by calculating the ratio r1=(T_{die}−T_{DBC})/(T_{DBC}−T_{HS}) between the difference of temperature between thee die of interest and the DBC layer T_{die}−T_{DBC}, and the difference of temperature between the DBC layer and the heat sink T_{DBC}−T_{HS}, it is possible to monitor a change of thermal resistance of the die attach layer. In example, in the case of weak thermal coupling between parallel dies, and referring to the previous example, in the case of negligible thermal coupling between parallel dies S11 and S21, an increase of this ratio means that the thermal resistance of the die attach layer increases in the same proportion.

Using this method, it can be demonstrated that within reasonable approximations, and under steady state thermal conditions, usually after a few seconds of operation at a stabilized power, the ratio r1 above corresponds to the ratio between the thermal resistances between the die and the DBC layer R_{die,DBC} and the thermal resistance between the DBC layer and the heat sink R_{DBC,HS}.

Thus, it is preferable to apply this method during a steady state thermal event of the power converter, the steady state operation being either purposely generated during a diagnostic procedure of the power converter or being detected during operation of the converter.

However, it is still possible to use the method to generate a damage indicator in a thermal transient situation as the ratio r1=(T_{die}−T_{DBC})/(T_{DBC}−T_{HS}) may still, under some circumstances, be independent of the dissipated power, and thus the method is not restricted to the steady state thermal case. The ratio r1 cannot then be interpreted as a thermal resistance ratio but as a damage indicator, which trend can still be monitored to evaluate the health state of the power module.

For example, step B may be executed less than 100 ms after step A, this sequence is repeated at regular time intervals during the lifetime of the product, and the ratio r1=(T_{die}−T_{DBC})/(T_{DBC}−T_{HS}) between the difference of temperature between the die of interest and the DBC layer T_{die}−T_{DBC}, and the difference of temperature between the DBC layer and the heat sink T_{DBC}−T_{HS}, is calculated, and it is possible to monitor a change of the damage parameter R of the die attach layer.

Here again, the method starts from a measurement of a temperature of a switch, that is maintained open, through a TSEP method, measuring a temperature T_{HS} of a heatsink and calculating the difference of temperature T1−T_{HS} between said first temperature T1 and said heatsink temperature T_{HS} to obtain a value of thermal resistance between said semiconductor switch in off condition and said heatsink.

With the same principle keeping any of the switches open while another switch of the same die is in function, measurements can be done for all the dies and layers under such dies.

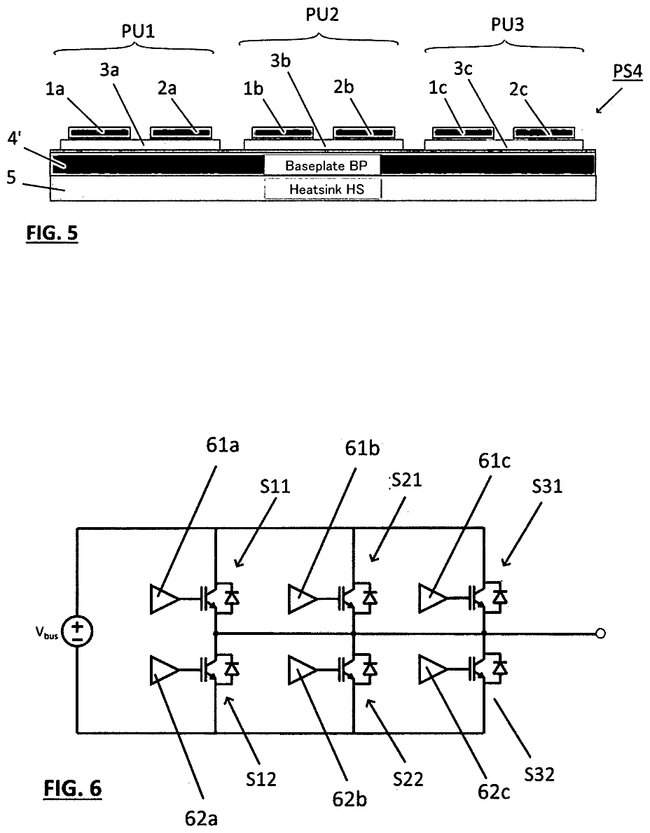

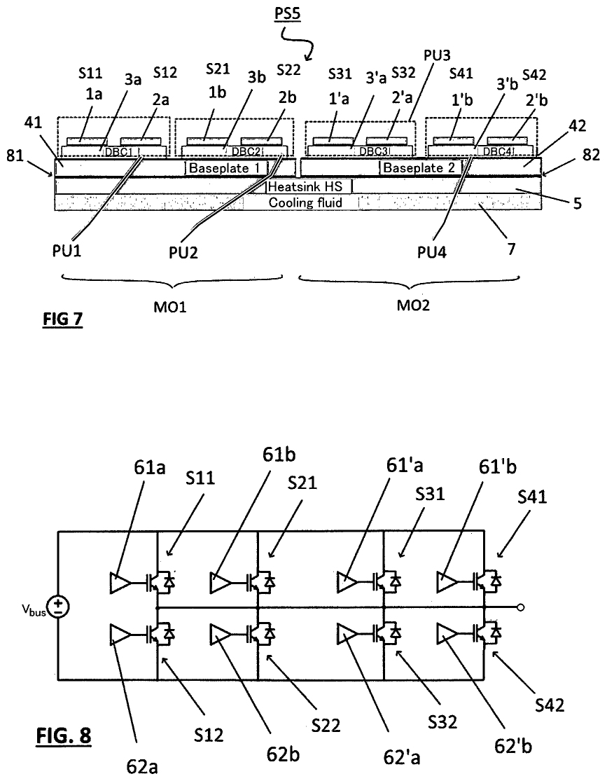

FIGS. 5 and 6 shows an embodiment where three half bridges are connected in parallel to an output terminal.

The power electronic system comprises three top switches S11, S21, S31 which are located respectively on dies 1a, 1b, 1c and three bottom switches S12, S22, S32 located on dies 2a, 2b, 2c respectively.

Each top and bottom switches has its own gate driver circuitry 61a for switch S11, 61b for switch S21, 61c for switch S31, 62a for switch S12, 62b for switch S22 and 62c for switch S32. The three half bridges 1a, 2a; 1b, 2b and 1c, 2c have their own DBC layers 3a, 3b, 3c attached to a common baseplate 4′ which is in turn attached to heatsink 5.

This embodiment corresponding to FIG. 9B is used to disclose another measurement to obtain thermal resistance between the dies and the baseplate.

When S11 and S12 of a first power unit PU1 are kept open in step 200, the thermal resistance between switch S11 and the baseplate may be compared to the thermal resistance between the baseplate 4′ and the heatsink 5, by maintaining top switch S11 and bottom switch S12 of a half-bridge open and measuring the temperature T_{B} of the baseplate using the temperature measurements of switch S11 and switch S12 which provide a temperature T_{S11}=T_{S12} equivalent to T_{B} in step 210 since these switches are off, the switching functions being carried out by top switches S21, S31 only in one hand, and by bottom switches S22, S32 only in the other hand, and at the same time measuring the temperatures of at least the top switch S21 (measure of T2=T_{PU2} in step 220), and measure of the temperature of the heatsink in step 225, and then by calculating the thermal resistance of a second power unit in step 230: R_{PU2}=(T_{S21}−T_{B})/(T_{B}−T_{HS}) or R_{PU2}=(T_{S22}−T_{B})/(T_{B}−T_{HS}) to compare the thermal resistance between the dies and the baseplate with the thermal resistance between the baseplate and the heatsink. The same measurements done on the other switches allow to obtain a complete knowledge of all ratios between the die attach layers 3a, 3b, 3c and the baseplate and between the baseplate and the heatsink. In this configuration where three half bridges are present, the maximum current capacity of the converter is approximately reduced by a factor ⅓.

Such measurement may be done on the design of FIGS. 3 and 4 having two half bridges, however, the current capability of the unit in such case is reduced by 50% which may limit the conditions of operations of the unit under measurement.

In order to characterize degradations of the units, the method comprises storing for each switch an initial ratio between first thermal resistance between the die of the switch and the common layer with other switches and second thermal resistance between said common layer and the common heatsink with the method disclosed and repeating said method during the life of said power electronic system to store further ratio between first thermal resistance and second thermal resistance and:
monitoring a change of said second thermal resistances during life of the power electronic system, assuming the first thermal resistance does not change, or
monitoring a change of said first thermal resistance during life of the power electronic system, assuming the second thermal resistance does not change.

In the present disclosure the temperature T_{HS} of the heatsink is acquired using one or several state-of-the-art temperature sensors such as a thermocouple, a thermistance, or an infrared detector.

According to the disclosure the thermal resistance between all switches Sx (x=1 to n) and the connecting layer such as a DBC layer Mj connecting thermally them to the heatsink of a module may be measured or at least evaluated together with the resistance between such connecting layer and the heatsink in initial conditions and during the life of the module to monitor evolution of such thermal resistance and ageing of the device. When a baseplate is present to receive several connecting or DBC layer, the resistance between the switches ant the baseplate may also be monitored.

The different measuring methods and steps may be realized through a software implemented in a processor of a controller of said power electronic system, said processor being further configured to provide commands to said power unit or power units to put said at least one semiconductor switch in said open state and configured to provide commands to generate said limited current in said at least one semiconductor switch in said open state.

Such software may be incorporated in a computer readable non-volatile medium such as a ROM or other medium.

One of the technological uses of this method in which a semiconductor switch is temporarily deactivated, is to monitor the temperature of a layer of interest Mj in a power electronic system made of one more power units or modules. The thermal resistance of a particular layer of the power module can be estimated by comparing a temperature difference between the semiconductor die and the layer of interest Mj, with a temperature difference between the layer Mj and the heatsink. This measurement can be performed online during the nominal operation of a power electronic module when each gate of parallel dies is individually controlled by its own gate driver (multichip configuration). Regularly repeating such measurement during life of the power module allows to monitor a localized degradation state of the power module. This will allow to perform a better knowledge of the degradation state of such module and therefore manage a better maintenance planning. Additionally, application of this invention removes the need of integrating thermistances in the power module, as the semiconductor die itself can perform the task when applying the method of the invention. Finally, this invention also does not require a knowledge or measurement of the power dissipated by the semiconductor die, which is a strong limitation in other thermal impedance approaches.

A further type of measurements may be done on a power electronic system PS5 as described in FIGS. 7 and 8.

In this design, four power units PU1, PU2, PU3, PU4 comprising top switch S11 on die 1a, top switch S21 on die 1b, top switch S31 on die 1c, top switch S41 on die 1d and a bottom switch S12 on die 2a, bottom switch S22 on die 2b, bottom switch S32 on die 2c, bottom switch S42 on die 2d and where the top switches are connected in parallel, and the bottom switches are connected in parallel.

The top and bottom switch dies of each power unit are attached to a common DBC layer 3a, 3b, 3′a, 3′b and two power units PU1, PU2 are regrouped in a first power module MO1 on a first baseplate 41 while the two other power units PU3, PU4 are regrouped in a second power module MO2 on a second baseplate 42. The baseplates 41, 42 are in turn attached to a heatsink 5 through a connecting layer 81, 82 such as thermal paste. The heatsink is in contact with a cooling fluid 7.

In FIG. 8, gate driver circuitries 61a, 62a, 61b, 62b, 61′a, 62′a, 61′b, 62′b independent for each device are represented.

In this configuration, the thermal resistance R_{PU1-HS} between S21, and/or S11, and/or S22 or S12 and the heatsink 5 may be compared to the thermal resistance R_{HS-CF} between the heatsink 5 and the cooling fluid 7, by maintaining all the devices of the power module MO2 comprising PU3 and PU4 open and measuring the temperature T_{HS} of the heatsink contact surface using the temperature measurements of one or a combination of the devices of the power module MO2, the switching functions being carried out by devices of module MO1, and at the same time measuring the temperatures T2 of at least one of the devices of module 1 (for example the temperature T_{S21}), and the temperature of the cooling fluid T_{CF}, and then calculating R=(T2−T_{HS})/(T_{HS}−T_{CF}) to compare the thermal resistance of the module MO1 and its connecting layer 41 with that between the heat sink contact surface and the cooling fluid.

The same measurements are done keeping all switches of the power module MO1 open, the switching functions being carried out by devices of module MO2 to compare the thermal resistance of the module MO2 and its connecting layer 42 with that between the heat sink contact surface and the cooling fluid.

Thus, in this configuration, it is possible to monitor a degradation of the material of the connecting layers 41, 42, in case the measurement is done repeatedly during the life of the power electronic system. Alternatively, it is possible to monitor a degradation of the mechanical contact between the module MO1 and the heat sink contact surface, for a reduction of the contact pressure due to an unfastening of the fixture system, or due to a degradation of the thermal interface material 81, such as for example, thermal paste pump out.

FIG. 9D provides a generalized flowchart where after an initialization phase at steps 375, 380 measurements are repeated where MOi modules are turned off, MOj modules are turned off and j≠i and T_{HS} is measured at step 400, T2 of modules MOj is measured at step 410, T_{CF} where layer CF is the baseplate is measured at step 420, the ratio r3=(T2−T_{HS})/(T_{HS}−T_{CF}) is measured at step 430, the ratio r3 of module is stored at step 450 and the test is repeated until all j modules are tested to compare at step 365 the ratios r3 values in order to detect a difference in such ratios.

The material of the connecting layers 41, 42 can be a thermal conductive paste, a carbon-based foil, or any material placed in between the power modules and the heat sink contact surface.

By combining measurements at the die level, the power unit level and the module level, it is possible to monitor the die to DBC thermal resistance, the DBC to baseplate thermal resistance and the baseplate to heatsink thermal resistance.

The measurements benefit to be done in a steady state operation of the power electronic system and in order to detect such a steady state operation and then monitor a thermal resistance ratio the process may comprise:
periodically recording at a time interval t_{sampling} the temperatures Tj of at least one semiconductor device j of the power electronic system such as a power converter and storing the data in a memory;
periodically calculating a temperature T_{mean,j} and a standard deviation σ_{mean,j} of at least the semiconductor j at a time interval tₑᵥₐₗ using a data sample Tnj . . . Tmj, such as an integration time t_{averaging} is at least a significant portion of the thermal constant of the power converter;
at least if the conditions T_{mean,j}>C1×T_{HS}, and σ_{mean,j}<C2×(T_{mean,j}−T_{HS}) are respected, doing the measurement process.

C1 is for example a constant larger than 1, such as a significant temperature difference exists between the heatsink and the semiconductor die of the power converter, and such as an acceptable accuracy of the measurements can be reached. For example, if T_{HS}=30° C., having C1=3, permits to have the measurements applied only if Tmean,j>90° C., ensuring that sufficient thermal gradients exits in the power converter. Alternatively, C1 may have different values such as C1=1.1, or preferably C1=2, or preferably C1=5.

The condition σmean,j<C2*(Tmean,j−T_{HS}) is the condition detecting the steady state nature of the operation, by comparing the standard deviation of the temperature samples with the average temperature difference between the semiconductor and the heat sink during the sampling time. C2 is a constant that is preferably minimized, and limited by the measurement error for Tmean,j−T_{HS}. For example, C2=0.2, preferably C2=0.1, preferably C2=0.05.

During near thermal steady state operation of the power converter, the ratio (T1−T_{HS})/(T2−T1) is the ratio between:
the thermal resistance between the layer Mj the connecting layer at the temperature T1 of the off state element, and the cooling means, that is temperature T_{CM} equals to T_{HS} or T_{CF} and
the thermal resistance between the active semiconductor (temperature T2) and the layer Mj (temperature T1),
   without errors introduced by delays in obtaining a thermal equilibrium so that the measurements can be done online without significantly affecting the converter performance or interrupting its operation.

The advantage of the steady state detection is that it is thus not needed to force the converter to apply an electrical steady state condition in order to achieve a thermal steady state condition. In this method, a thermal steady state condition is detected during the normal operation of the converter, and when detected, the measurement method is processed.

The time interval t_{sampling} may be a multiple of the inverse of the switching frequency of a power converter: t_{sampling}=n/f_{PWM}. For example, n=100, preferably n=10. For example, f_{PWM}=10 kHz, and t_{sampling} is 10 μs, preferably 1 μs. In another example, n is the number of active semiconductors dies of the converter, and the temperature of each die is measured one after the other at every switching period.

In another example, the temperature T_{mean,j} may be calculated using the arithmetic mean, the median of the data sample Tnj . . . Tjm. The definition of the standard deviation is any definition of the standard deviation commonly accepted in the field of statistical analysis.

The time interval t_{averaging} is a time sufficiently long such compared to the thermal constant of the power converter or the area to be investigated. It may be chosen a priori by performing thermal impedance measurements and measuring the time at which a quasi-steady state thermal state is reached and taking for a safety margin to consider a possible thermal resistance degradation. For example, with a thermal constant of the power converter of 3 minutes, t_{averaging} may be 1 minute for layers close to the die and for which the time to reach a quasi-steady state is faster than the thermal constant of the power converter, and around 3 minutes or even 9 minutes for the complete converter measurements. In another example, the thermal constant of the power converter being 30 seconds, t_{averaging} may be between 15 s and 30 s for internal layers up to 270 s for the complete converter.

The time interval tₑᵥₐₗ is, for example a time interval larger than t_{averaging}, for example tₑᵥₐₗ=t_{averaging}, or tₑᵥₐₗ=1.5*t_{averaging}, or tₑᵥₐₗ=10*t_{averaging}.

In the designs where the switches of powers units PU can be controlled independently from each other, in addition to measure the thermal impedance between a power unit and a heatsink, the coupling impedance between a power unit PUi and a power unit PUj (i≠j) may be measured by a sequence shown in FIG. 9C comprising:
1/ switching off all PUj, and maintaining PUi active at step 300,
2/ measuring the temperature Ti of all PUi at step 310,
3/ measuring the temperature of the heatsink T_{HS} at step 320,
4/ calculating the temperature differences ΔTi=Ti−T_{HS} at step 330,
5/ comparing the ΔTi between power units such as to detect a change in a coupling thermal resistance at step 340.

Optionally, the power dissipated in PU1 may be estimated.

This sequence may also be repeated according to step 350 several times during the life of the product and may also be applied successively to several of all PUi of the PS.

Thus, advantageously, a change of thermal impedance of PUi, and/or of coupling terms with PUj (i≠j) can be measured.

When the measurement sequence is applied to all PUi successively, and the power dissipated Pi in the PUi is measured or estimated, and a thermal steady state is obtained before starting the sequence, a data representation consists in arranging the temperature measurements in n matrices n×n: When power is dissipated only in PU1:

$$[ \begin{matrix}Δ {T}_{1} \\ … \\ … \\ … \\ Δ {T}_{n}\end{matrix} ] = [ \begin{matrix}{R}_{11} & ⋯ & {R}_{1 i} & ⋯ & {R}_{1 n} \\ ⋮ & & ⋱ & & ⋮ \\ {R}_{n 1} & ⋯ & {R}_{ni} & ⋯ & {R}_{nn}\end{matrix} ] [ \begin{matrix}{P}_{1} \\ 0 \\ … \\ … \\ 0\end{matrix} ] \text{=>} M 1 = [ \begin{matrix}{R}_{11} & ⋯ & 0 & ⋯ & 0 \\ ⋮ & & ⋱ & & ⋮ \\ {R}_{n 1} & ⋯ & 0 & ⋯ & 0\end{matrix} ]$$

When power is dissipated only in PUi:

$$[ \begin{matrix}Δ {T}_{1} \\ … \\ … \\ … \\ Δ {T}_{n}\end{matrix} ] = [ \begin{matrix}{R}_{11} & ⋯ & {R}_{1 i} & ⋯ & {R}_{1 n} \\ ⋮ & & ⋱ & & ⋮ \\ {R}_{n 1} & ⋯ & {R}_{ni} & ⋯ & {R}_{nn}\end{matrix} ] [ \begin{matrix}0 \\ ⋯ \\ {P}_{1} \\ … \\ 0\end{matrix} ] \text{=>} Mi = [ \begin{matrix}0 & ⋯ & {R}_{1 i} & ⋯ & 0 \\ ⋮ & & ⋱ & & ⋮ \\ 0 & ⋯ & {R}_{ni} & ⋯ & 0\end{matrix} ]$$

Thus, by application of the principle of superposition and summing the matrices Mi as:

$$M = \sum Mi = [ \begin{matrix}{R}_{11} & {R}_{1 i} & {R}_{1 n} \\ ⋮ & ⋱ & ⋮ \\ {R}_{n 1} & {R}_{ni} & {R}_{nn}\end{matrix} ]$$

A thermal resistance matrix, including the coupling terms (non-diagonal terms) is generated. Thus, be applying this method at several times during the life of the product, it is possible to monitor a change in the thermal resistance Rᵢᵢ or of a coupling resistance Rᵢⱼ (i≠j).

An example to measure the power dissipated in the PUi of a converter is to use an electrical model Pi (IL, Vbus, fPWM, Ti, α . . . ) of the PU, where IL is the measured load power, Ti is the measured temperature of PUi, Vbus is the known or measured bus voltage of the PUi or of the converter, fPWM is the switching frequency, and a is the duty cycle.

Alternatively, without measuring the dissipated power, the ratio between the thermal resistance of PU1 and the coupling resistance with PUi is measured, arranging the temperature measurements ΔTi in a vector gives:

$$[ \begin{matrix}Δ {T}_{1} \\ … \\ … \\ … \\ Δ {T}_{n}\end{matrix} ]$$

By normalizing the temperatures ΔTi with respect to ΔT1, a state vector D is obtained which represents the state of thermal resistance coupling between the PUi at instant t of the measurement:

$$D ( t ) = [ \begin{matrix}1 \\ ⋯ \\ \frac{Δ {T}_{i}}{Δ {T}_{1}} \\ ⋯ \\ \frac{Δ {T}_{i}}{Δ {T}_{n}}\end{matrix} ]$$

By repeating the measurement at several times and comparing the vectors D(t), it is possible to detect a change in coupling resistance between the PUi.

The method of the present disclosure may thus provide a simple way to measure temperature parameters in a power electronic system where a semiconductor switch may be used in an off state to measure a temperature of a connection layer between such semiconductor switch and a heat source or such semiconductor switch and other semiconductor switches in operation. This method permits to measure contact degradation between dies and a common connecting layer when knowing the temperature of a last temperature dissipating layer under opposite to the die with respect to such connecting layer. This method targets power electronic converters where the individual semiconductor devices are driven independently, such that the temperature can be measured sequentially on each semiconductor with a gate that can be controlled independently and where several dies share a thermal connection though a layer Mj. This is typically the case in a multichip configuration where several semiconductors are electrically connected in parallel to perform the function of a single switch and to share the electrical current.

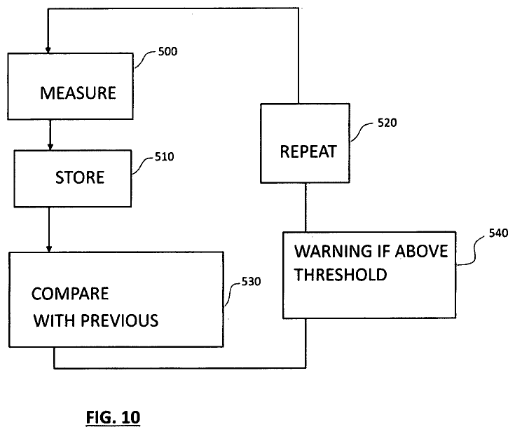

FIG. 10 provides a general flowchart of a on-line measurement method which provides measurements 500 along the life of the system, storage 510, comparison with previous measurements 530, provision of a warning 540 when a value such as thermal resistance or thermal resistance ratio is above a threshold and repetition 520 of the measurement after a determined time delay.

Such method allows to measure temperature of individual switches devices in multichip power modules having different configuration in order to estimate the thermal resistance of layers between one cold device and one hot device. A change of the thermal resistance due to ageing of the power module will be correlated with a degradation of the layer.

The disclosed method may particularly be used in DC/DC power converters, AC/AC power converters and DC/AC power inverters, comprising parallel current conducting switches with switches with separate gate inputs such as converters used in wind power systems, photovoltaic inverters, electric vehicles and traction applications.

1. Method for measuring temperatures or thermal resistances in a power electronic system comprising at least a first power unit and a heat source thermally connected through a connection layer to a cooling means, comprising, while said first power unit is in an open state such as it does not dissipate heat, providing a limited current in said first power unit said limited current being unable to turn said first power unit in a power conducting state, measuring a temperature T1 of said first power unit using a thermal sensitive electrical parameter TSEP of said first power unit, calculating a temperature T_{CL} of the connection layer as being equal to such first temperature T1 since said first power unit in an open state does not generate heat.

2. Method according to claim 1 wherein said heat source is a second power unit.

3. Method according to claim 2 and comprising further measuring a temperature T_{CM} of the cooling means and calculating the difference of temperature T1−T_{CM} between said connection layer and said cooling means.

4. Method according to claim 3 comprising further:
measuring a temperature T2 of said second power unit using a TSEP of said second electronic unit,
comparing the difference T1−T_{CM} with the difference T2−T_{CM}
comparing the thermal resistance R_{2-CL} between the second power unit and the connection layer to the thermal resistance R_{CL-CM} between the connection layer and the cooling means through the calculations:
R_{2-CL}/R_{CL-CM}=(T_{CL}−T_{CM})/(T2−T_{CL})=(T1−T_{CM})/(T2−T1) since T1=T_{CL} such calculation being independent of Q, where Q is the heat flow value applied between said second power unit and said connection layer.

5. Method according to claim 4 wherein said first power unit and said second power units are semiconductor switches thermally connected to said connection layer Mj through a first stack of material layers M1, . . . , Mj−1, wherein said cooling means is a heatsink and wherein said connection layer is thermally connected to said heatsink through a second stack of material layers Mj+1, . . . Mn.

6. Method according to claim 5 wherein said first power unit and said second power units are semiconductor switches, said connection layer being a ceramic layer such as a direct bonded copper ceramic layer or an active metal brazed layer attached directly to said heatsink or attached to said heatsink through a baseplate BP.

7. Method according to claim 4 wherein said first power unit is a first half bridge power unit comprising a first top switch and a first bottom switch, said first top switch and said first bottom switch having dies attached to a first ceramic layer such as a direct bonded copper ceramic layer or an active metal brazed layer DBC1 through a first die attach layer and said second electronic unit is a second half bridge power unit comprising a second top switch and a second bottom switch, said top switch and bottom switch having dies attached to a second direct bonded copper ceramic layer DBC2 through a second die attach layer and wherein said first direct bonded copper ceramic layer DBC1 and second direct bonded copper ceramic layer DBC2 are attached to a common heatsink HS through a solder layer and a baseplate layer BP, said method comprising turning off both the first top switch and the first bottom switch of the first half bridge power unit while the second top switch and the second bottom switch of the second half bridge power unit are active and
measuring a temperature T2 of the second top switch through TSEP of said second top switch, measuring a temperature T1 of the first top switch or the first bottom switch through TSEP of said first top switch or said first bottom switch by providing a limited current in said first top switch or said first bottom switch, said limited current being unable to turn said first top switch unit in a power conducting state, considering the temperature of the baseplate as equal to said temperature T1 calculating the temperature difference between said second top switch and the baseplate R_{2-BP}=T2−T_{BP}=T2−T1
measuring a temperature of the heatsink T_{HS} and then calculating a ratio r2=(T2−T_{BP})/(T_{BP}−T_{HS}) to compare the thermal resistance of the second die attach layer, the second DBC layer, the solder layer with that between the baseplate and the heat sink.

8. Method according to claim 4 wherein each power unit is turned off in sequence while the other power unit is active.

9. Method according to claim 7 wherein said power electronic system comprises more than one half bridge power units and wherein one of said half bridges is turned off to provide a temperature measurement of the baseplate while measurements of thermal resistance and thermal resistance ratios are conducted on the others of said half bridges, each of said half bridges being turned off in sequence while the others are active to provide a complete testing of the half bridges of the power electronic system.

10. Method according to claim 4 wherein the power electronic system comprises a first power module having a first pair of half bridges power units each having a top switch an a bottom switch and a DBC layer connected to a first baseplate and comprises a second power module having a second pair of half bridge power units each having a top switch an a bottom switch and a DBC layer connected to a second baseplate, said first baseplate and said second baseplate being attached through a thermal contact material to a heatsink HS in contact with a cooling fluid CF, the power electronic system comprising further gate driver circuitries independent for each of said switches, said method comprising measuring the thermal resistance R_{PU1-HS} between a top switch or a bottom switch of a first power module and the heatsink and the thermal resistance R_{HS-CF} between the heatsink and the cooling fluid and comparing said thermal resistances through the steps of:
maintaining all the devices of a second power module open and measuring the temperature T_{HS} of the heatsink contact surface using a TSEP temperature measurements of one or a combination of the switches of said second power module, while the switching functions of the power electronic system are carried out by the switches of the first power module, and at the same time measuring the temperatures T2 of at least one of the devices of said first power module through its TSEP, measuring a temperature T_{CF} of the cooling fluid, and,
calculating a ratio r3=(T2−T_{HS})/(T_{HS}−T_{CF}) to compare the thermal resistance of the first power module, first baseplate, first thermal contact material with the thermal resistance between the heat sink contact surface and the cooling fluid, said method comprising further carrying the same steps with the switches of the first power module open while the switching functions of the power electronic system are carried out by the switches of the second power module.

11. Method according to claim 1 wherein said first power unit is forced in said open state during the measurements of temperature or thermal resistances.

12. Method for monitoring the thermal resistance of power units of a power electronic system comprising acquiring initial thermal resistances of such power units through the method of claim 4, storing said initial thermal resistances and a ratio between an initial thermal resistance between said power units and the connection layer of such power units to the thermal resistance between the connection layer and the cooling means, repeating said method during the life of the power electronic system to acquire further thermal resistances and further ratios, comparing said further thermal resistances and said further ratios to said initial thermal resistances and said initial ratios to detect a modification of thermal resistances and ratios.

13. Method according to claim 12 comprising comparing a modification of said thermal resistance to a predefined threshold value and raising a warning in case of a value of said thermal resistances or said ratios above said threshold value.

14. Method according to claim 1 comprising:
periodically recording at a time interval t_{sampling} a temperature Tj of at least one semiconductor device j of the power electronic system and storing said temperature Tj in a memory;
periodically calculating a mean temperature T_{mean,j} and a standard deviation σ_{mean,j} for at least said semiconductor device j at a time interval tₑᵥₐₗ using a data sample Tnj . . . Tmj, with an integration time t_{averaging} of at least half of the thermal constant of the power converter;
at least if the conditions T_{mean,j}>C1×T_{HS}, and σ_{mean,j}<C2×(T_{mean,j}−T_{HS}), where C1 is a constant larger than 1 and C2 a constant smaller than 1, are respected.

15. Method according to claim 14 where C1 is a constant in a range between 1.1 to 5.

16. Method according to claim 14 where C2 is a constant between 0.2 to 0.05, the condition σ_{mean,j}<C2*(T_{mean,j}−T_{HS}) being a condition detecting the steady state nature of the operation by comparing a standard deviation of the temperature samples with an average temperature difference between the semiconductor and the heat sink during the sampling time.

17. Method according to claim 14 where the time interval t_{sampling} is a multiple of the inverse of the switching frequency of a power converter: t_{sampling}=n/f_{PWM}.

18. Method according to claim 14 where the temperature T_{mean,j} is calculated using an arithmetic mean, or a median of the data sample Tnj . . . Tjm.

19. Method according to claim 14 where the integration time t_{averaging} is greater than a thermal constant of the power electronic system.

20. Method according to claim 14 where the time interval tₑᵥₐₗ is a time interval larger than t_{averaging}.

21. Method according to claim 7 wherein the switches of powers units PUx, x=1 to n, where n is the total number of switches, being controlled independently from each other the method comprises measuring the coupling impedance between a power unit PUi and a power unit PUj i≠j, by a sequence comprising:
1/ switching off all switches of modules PUj, and maintaining the switches of modules PUi active,
2/ measuring the temperature Tx of all modules PUx,
3/ measuring the temperature of the heatsink T_{HS},
4/ calculating the temperature differences ΔTx=Tx−T_{HS},
5/ comparing the ΔTi with ΔTx such as to detect a change in a coupling thermal resistance between modules.

22. Method according to claim 21 wherein said sequence is repeated several times during the life of the product.

23. Method according to claim 21 comprising measuring the power dissipated in the power unit PUi using an electrical model Pi(IL, Vbus, fPWM, Ti, α . . . ) of such power unit, where IL is the measured load power, Ti is the measured temperature of PUi, Vbus is the known or measured bus voltage of the power unit PUi, fPWM is the switching frequency of such power unit, and a is the duty cycle of such power unit, and calculating coupling resistances as ΔTk/Pi.

24. Software comprising instructions for implementing the method of claim 1 when executed in a controller of said power system.

25. Computer readable non-volatile medium on which the software of claim 24 is recorded.
